(19) United States
(12) Patent Application Publication
(10) Pub. No.: US 2015/0368535 A1
(43) Pub. Date: Dec. 24, 2015

(54) GRAPHENE COMPOSITES AND METHODS OF FABRICATION

(71) Applicant: UNITED TECHNOLOGIES CORPORATION, Hartford, CT (US)

(72) Inventors: Sameh Dardona, South Windsor, CT (US); Wayde R Schmidt, Pomfret Center (UC); William A Veronesi, Hartford, CT (US); Tahany I El-Wardany, Bloomfield, CT (US)

(21) Appl. No.: 14/763,907

(22) PCT Filed: Jan. 28, 2013
(86) PCT No.: PCT/US2013/023439

§ 371 Date: Jul. 28, 2015

(51) Int. Cl. C09K 5/14; C23C 24/04; H01B 1/04

(52) U.S. Cl. CPC C09K 5/14; H01B 1/04; C23C 24/04; B33Y 10/00

(57) ABSTRACT

A composite material includes a graphene-filler composite and method of manufacturing.

### BACKGROUND

The present disclosure relates generally to graphene composites.

Ensuring energy efficiency in products requires materials with superior properties. Due to its thermal and electrical properties copper is often used in the construction of components with good electrical and thermal conductivities. Recent research advancements have resulted in the discovery of a new class of materials that has electrical, thermal and mechanical properties exceeding those of bulk copper. This material is a two-dimensional structure of carbon atoms and is known as “graphene”.

### SUMMARY

A composite material according to one disclosed non-limiting embodiment of the present disclosure includes a graphene-filler composite.

A further embodiment of the foregoing embodiment of the present disclosure includes graphene-filler composite includes a multiple of graphene layers each separated one from another by a filler layer.

In the alternative or additionally thereto, the foregoing embodiment includes the filler layer is a copper.

A further embodiment of any of the foregoing embodiments, of the present disclosure wherein the graphene-filler composite includes a homogenous mixture of graphene and filler.

In the alternative or additionally thereto, the foregoing embodiment wherein the filler layer is a copper.

A further embodiment of any of the foregoing embodiments, of the present disclosure wherein the graphene-filler composite forms a conductive member.

A further embodiment of any of the foregoing embodiments, of the present disclosure wherein the graphene-filler composite forms a wire.

A further embodiment of any of the foregoing embodiments, of the present disclosure wherein the graphene-filler composite forms a heat sink

A method of manufacturing a graphene-filler composite material according to one disclosed non-limiting embodiment of the present disclosure includes manufacturing a multiple of graphene layers each separated one from another by a filler layer.

In the alternative or additionally thereto, the foregoing embodiment includes premixing graphene sheets with a filler.

In the alternative or additionally thereto, the foregoing embodiment includes introducing the pre-mixed powder into a cold spray deposition system.

In the alternative or additionally thereto, the foregoing embodiment includes premixing graphene sheets with a copper powder.

In the alternative or additionally thereto, the foregoing embodiment includes introducing the pre-mixed powder into a cold spray deposition system.

In the alternative or additionally thereto, the foregoing embodiment includes additive manufacturing the multiple of graphene layers each separated one from another by the filler layer.

In the alternative or additionally thereto, the foregoing embodiment includes additive manufacturing the multiple of graphene layers each separated one from another by a copper filler layer. In the alternative or additionally thereto, the foregoing embodiment includes premixing graphene sheets with a conductive material.

In the alternative or additionally thereto, the foregoing embodiment includes premixing graphene sheets with a copper powder.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a general schematic view of a multilayer composite according to one non-limiting embodiment;

FIG. 2 is a general schematic view of a combined chemical vapor deposition and electron beam physical vapor deposition system according to one non-limiting embodiment;

FIG. 3 is a general schematic view of a combined chemical vapor deposition and electron beam additive manufacturing system according to another non-limiting embodiment;

FIG. 4 is a general schematic view of a homogeneous composite according to one non-limiting embodiment;

FIG. 5 is a general schematic view of a laser additive manufacturing system according to another non-limiting embodiment;

FIG. 6 is a general schematic view of an electron beam additive manufacturing additive manufacturing system according to another non-limiting embodiment; and

FIG. 7 is a general schematic view of a cold spray additive manufacturing system according to another non-limiting embodiment.

### DETAILED DESCRIPTION

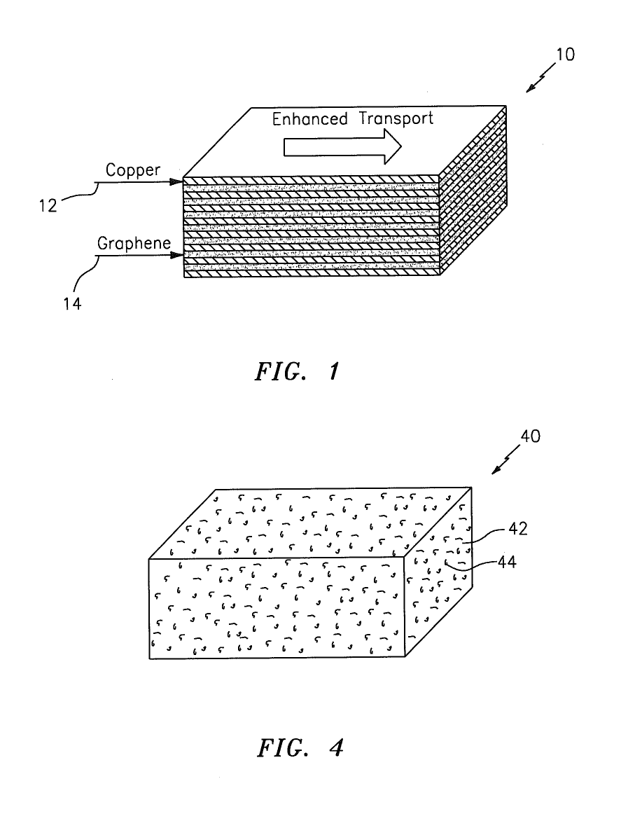

FIG. 1 schematically illustrates a multilayer graphene-filler composite 10 manufactured via, for example, additive manufacturing methods. In the disclosed non-limiting embodiment, a filler layer 12 is illustrated in the disclosed non-limiting embodiment as copper (Cu), however, any conductive material such as aluminum, steel, nickel, metal-based alloys, intermetallics, and others will benefit herefrom. A graphene layer 14 separates each filler layer 12. Although the multilayer graphene-filler composite 10 is schematically illustrated as a block-shape, it should be appreciated that any shape may be built-up. For example, the multilayer graphene-filler composite 10 may be manufactured as a wire, a cylinder or a thin sheet. Thus, the multilayer graphene-filler composite 10 may replace conductive members such as wires, heat sinks, circuit interconnects, heat exchanger tubes and fins as well as other components.

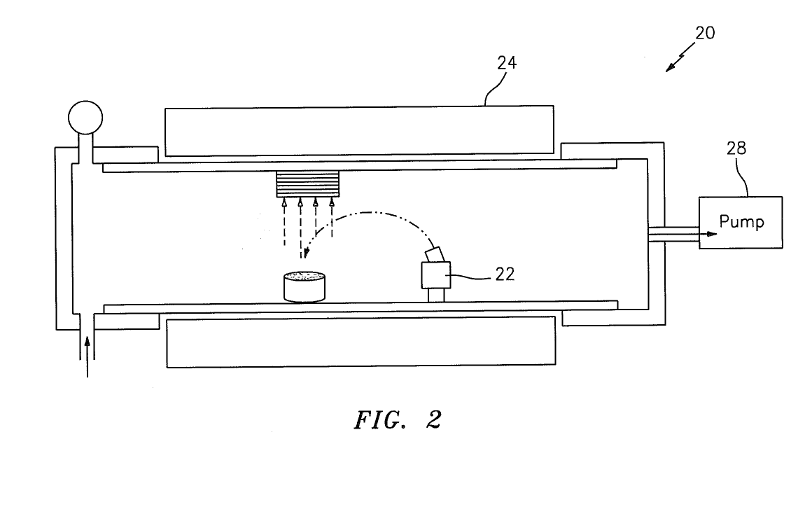

With reference to FIG. 2, in one disclosed non-limiting embodiment, deposition of the graphene layer 14 and the filler layer 12 such as a copper for the manufacture multilayer graphene-filler composite 10 is with a combined chemical vapor deposition (CVD) and electron beam physical vapor deposition system 20. The system 20 generally includes an electron gun 22 within a tube furnace vacuum chamber 24. The tube furnace vacuum chamber 24 is evacuated by a pump 28 and receives a gas flow such as hydrogen and methane.

The filler, such as copper, is evaporated into atoms by the electron gun 22 to form a gas that is deposited and condenses onto a respective graphene layer 14. The application continues in an alternating sequence of the graphene layers 14 and filler layers 12. The filler to be deposited is heated as a powder, using the electron beam gun, within the tube furnace vacuum chamber 24 to vaporization then deposited on a substrate to form the required thin film layer 12.

Electron beam physical vapor deposition also facilitates relatively fast deposition rates with a wide range of materials with controllability and repeatability of thin film properties. Such depositions facilitate increased conductivity. Combined CVD and electron beam physical vapor deposition facilitates manufacture of the multilayer graphene-filler composite 10 such as a nano-sized graphene and copper composite, which may reduce conduction losses by nominally 20%. The filler, which in the disclosed non-limiting embodiment includes copper atoms, provide charge carriers that move with negligible resistance through the graphene layers 14. Furthermore, the multilayers of graphene operate as parallel transport channels with a lower total effective resistance. Typically, the multilayer graphene-filler composite 10 with a copper filler layer 12 provides thermal and electrical properties exceeding those of bulk copper.

The graphene layer 14 deposition method, using CVD, according to one disclosed non-limiting embodiment generally includes: location of a filler material substrate such as copper in the tube furnace vacuum chamber 24; evacuation of the tube furnace vacuum chamber 24; back filling the tube furnace vacuum chamber 24 with hydrogen gas; heating to approximately 900° C. and maintaining a hydrogen gas pressure of approximately 40 mTorr under a 2 sccm (standard cubic centimeter per minute) flow rate; then introducing 35 sccm of methane gas for a desired period of time at a total pressure of approximately 500 mTorr. This methodology results in a predominantly uniform monolayer of graphene; on the scale of, for example, many centimeters per side, with minimal defects. The growth mechanism involves carbon nucleation sites that adsorb to the copper surface and then grow with the addition of carbon to the edges of these growth domains. The growth domains increase in size from additional carbon atoms being adsorbed to the edges of the nucleation sites until the domains join, forming a continuous graphene layer. Higher graphene growth rates, with generally larger domains, can be achieved at high temperatures of approximately 1652-1922° F. (900-1050° C.). Since the growth rate of graphene strongly depends on temperature, a continuous monolayer is more readily achieved at temperatures greater than 1922° F. (1050° C.). The low solubility of carbon in copper self-limits the growth process, i.e., graphite formation is avoided.

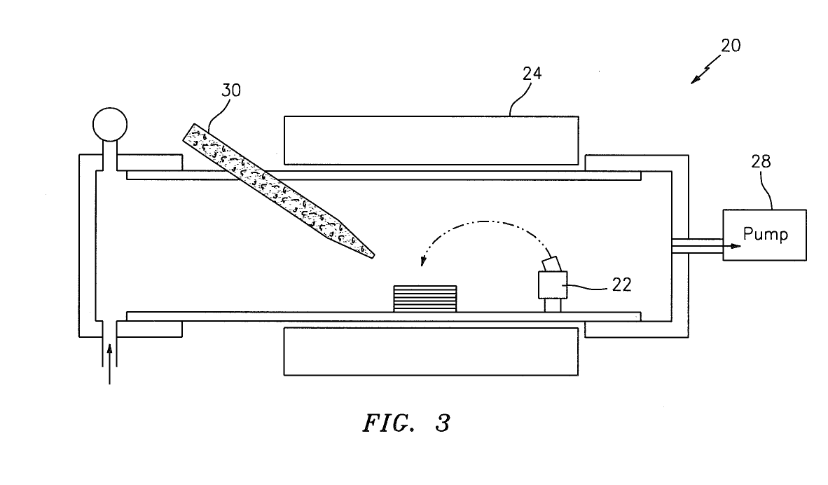

Additive manufacturing formation of the multilayer graphene-filler composite 10 in which graphene exists as continuous directional monolayers is amenable to electron beam additive manufacturing due primarily to the requirement that both electron beam additive manufacturing and CVD are performed under similar vacuum conditions. Therefore integration of a CVD tube furnace into the electron beam additive manufacturing system (FIG. 3) is readily available to ensure the fabrication of continuous directional monolayers of graphene with enhanced electron transport.

With reference to FIG. 3, in another disclosed non-limiting embodiment, the filler layer 12 such as copper is applied as a powder through a powder feeder 30. The powdered filler is then melted onto each respective graphene layer 14 by the electron gun 22. In this process, the graphene layer is deposited via CVD. The alternating sequence of graphene and copper deposition is continued to create the multilayer composite structure 10.

With reference to FIG. 4, a homogeneous graphene-filler composite 40 is manufactured via, for example, additive layer manufacturing methods with a mixture of graphene powder 42 and filler powder 44. In the disclosed non-limiting embodiment, the filler powder 44 is illustrated in the disclosed non-limiting embodiment as a copper powder, however, any conductive material such as aluminum, steel, nickel, metal-based alloys, intermetallics, and others will benefit herefrom. Proof-of-concept experiments have utilized graphene sheets less than 2 nm thick and approximately 5 μm wide premixed with copper powders by ball milling to obtain a homogenous mixture of the powders.

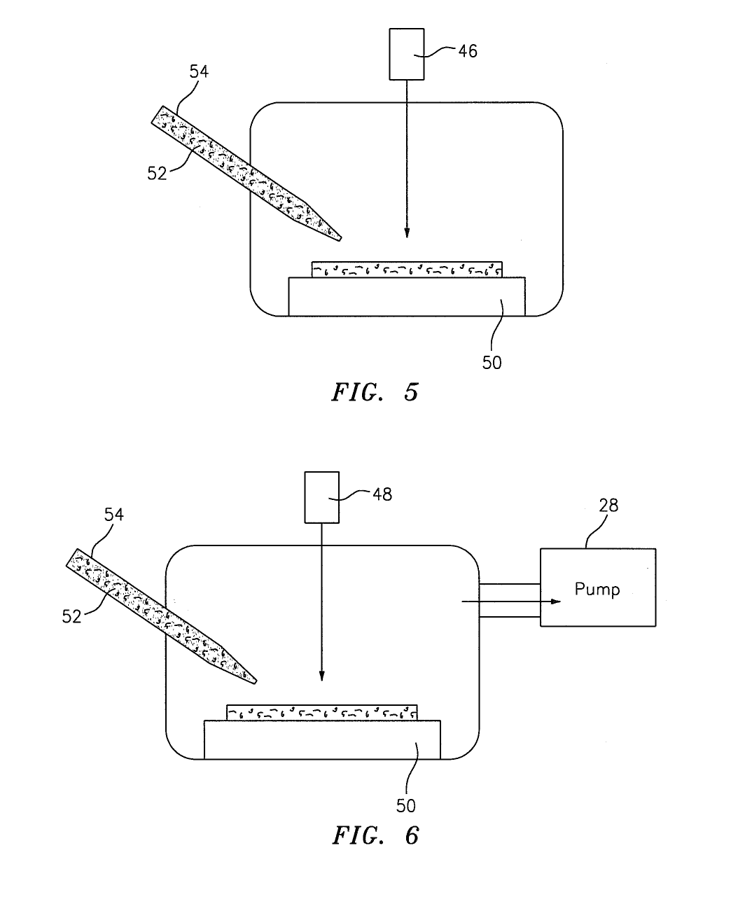

With reference to FIG. 5, in another disclosed non-limiting embodiment, the formation of homogeneous graphene-filler composite 40 may include laser and electron beam additive manufacturing (FIG. 6) deposition. In such techniques, a laser 46 (FIG. 5) or electron-beam gun 48 (FIG. 6) is directed at a substrate 50 to create a melt pool. The pre-mixed powder 52 such as graphene powder 42 and filler powder 44 or other derivatives of coated powders, i.e. copper-coated graphene, is then added to the melt pool. The added material enlarges the melt pool. To form the desired geometry, the laser or electron beam is rastered across the substrate 50 while pre-mixed powder 52 is selectively provided to the melt pool. The pre-mixed powder may be, for example, introduced into through a powder feeder 54.

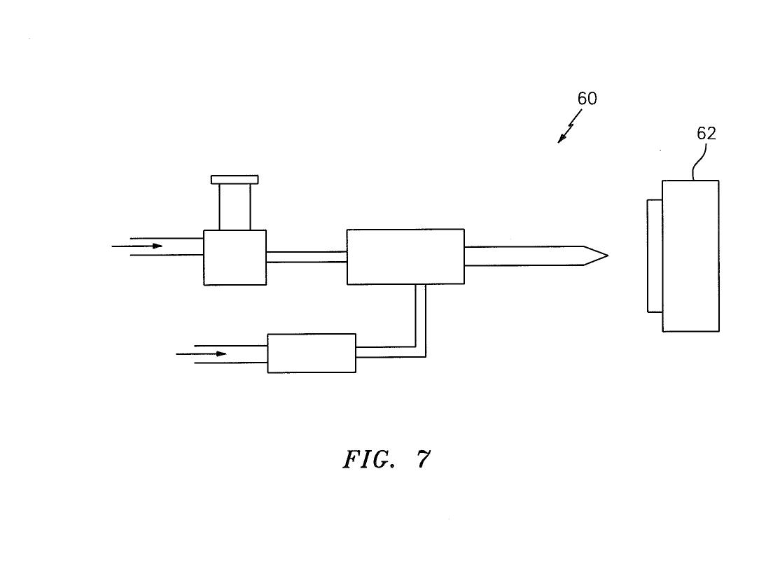

With reference to FIG. 7, in another disclosed non-limiting embodiment, the formation of homogeneous graphene-filler composite 40 may include a cold spray system 60 that is utilized to produce dense solid components and that incorporate high levels of work into the process of densification. Cold gas-dynamic spraying (cold spray) may be utilized as an Additive Manufacturing (AM) process. One example cold spray system 60 is that manufactured by Cold Gas Technology GmbH and available through Flame Spray Technologies USA of Grand Rapids Michigan.

The cold spray system 60 exposes a substrate 62 such as a ceramic or metal to a high velocity (300-1500 m/s) jet of relatively small (1-100 μm) powdered particles accelerated by a supersonic jet of compressed gas. The cold spray system 60 accelerates the pre-mixed copper and graphene powders 52 toward the substrate 62 such that the powdered copper and graphene particles deform on impact to generate high strain rate plasticity. This plasticity works the powders metals, densifies the structure, and due to the high strain rate of the process, recrystallizes nano-grains in the deposited material.

The cold spray process disclosed herein selects the combination of particle temperature, velocity, and size that allows spraying at a temperature far below the melting point of the premixed powdered copper and graphene which results in a layer 24 of particles in their solid state. The cold spray system 60 also offers significant advantages that minimize or eliminate the deleterious effects of high-temperature oxidation, evaporation, melting, crystallization, residual stresses, de-bonding, gas release, and other common problems of other additive manufacturing methods yet provides strong bond strength on coatings and substrates.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should also be understood that although a particular component arrangement is disclosed in the illustrated embodiment, other arrangements will benefit herefrom.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

1-17. (canceled)

18. A composite material comprising:
a graphene-filler composite, said graphene-filler composite includes a homogenous mixture of graphene and filler.

19. The graphene-filler composite material as recited in claim 18, wherein said graphene-filler composite includes a multiple of graphene layers each separated one from another by a filler layer.

20. The graphene-filler composite material as recited in claim 19, wherein said filler layer is a copper.

21. The graphene-filler composite material as recited in claim 18, wherein said graphene-filler composite includes a homogenous mixture of graphene and filler.

22. The graphene-filler composite material as recited in claim 18, wherein said filler layer is a copper.

23. The graphene-filler composite material as recited in claim 18, wherein said graphene-filler composite forms a conductive member.

24. The graphene-filler composite material as recited in claim 18, wherein said graphene-filler composite forms a wire.

25. The graphene-filler composite material as recited in claim 18, wherein said graphene-filler composite forms a heat sink.

26. A method of manufacturing a graphene-filler composite material comprising:
cold spraying a homogenous mixture of graphene and filler.

27. The method as recited in claim 26, further comprising premixing graphene sheets with a filler.

28. The method as recited in claim 27, further comprising introducing the pre-mixed powder into a cold spray deposition system.

29. The method as recited in claim 26, further comprising premixing graphene sheets with a copper powder.

30. The method as recited in claim 29, further comprising introducing the pre-mixed powder into a cold spray deposition system.

31. The method as recited in claim 20, further comprising additive manufacturing the multiple of graphene layers each separated one from another by the filler layer.

32. The method as recited in claim 20, further comprising additive manufacturing the multiple of graphene layers each separated one from another by a copper filler layer.

33. A composite material comprising:
a graphene-filler composite with a multiple of graphene layers each separated one from another by a filler layer.

34. The graphene-filler composite material as recited in claim 33, wherein said filler layer is a copper.

35. The graphene-filler composite material as recited in claim 33, wherein said graphene-filler composite forms a conductive member.

36. The graphene-filler composite material as recited in claim 33, wherein said graphene-filler composite forms a wire.

37. The graphene-filler composite material as recited in claim 33, wherein said graphene-filler composite forms a heat sink.
